(19) United States
(12) Patent Application Publication
(10) Pub. No.: US 2012/0245882 A1
(43) Pub. Date: Sep. 27, 2012

(54) WAFER TILT DETECTION SYSTEM

(75) Inventors: Hu Yu Hau, Taoyuan County (TW); Liau Shiuan-Kai, Taipei City (TW); Ching-Hua Cho, Hsinchu City (TW); Li Yung Li, Miaoli County (TW); Tseng Chia Hao, Hsinchu City (TW); Chenghui Chen, Taichung County (TW); Tsai Yuh Tong, Hsinchu City (TW)

(73) Assignee: Macronix International Co., Ltd.

(21) Appl. No.: 13/072,035

(22) Filed: Mar. 25, 2011

(51) Int. Cl. G01K 3/00; G06F 15/00

(52) U.S. Cl. 702/130; 374/102; 374/E03.001

(57) ABSTRACT

A method of improving wafer yield by accurately identifying tilted wafer conditions may include providing inquiry signals in gaps defined between machine signals where the inquiry signals relate to temperature information indicative of a temperature of a hot plate having an item placed thereon, receiving the temperature information, and determining a seating condition of the item based on a comparison of the temperature information to an expected heat profile for a fully seated item. A corresponding apparatus is also provided.

### TECHNOLOGICAL FIELD

Embodiments of the present invention generally relate to semiconductor wafer manufacturing and, more particularly, relate to a process for detection of wafer tilt in connection with photolithography processes.

### BACKGROUND

Since the advent of computers, there has been a steady drive toward producing smaller and more capable electronic devices, such as computing devices, communication devices and memory devices. In order to reduce the size of such devices while maintaining or improving their respective capabilities, the size of components within the devices must be reduced. Several of the components within electronic devices are made from semiconductor materials, which in some cases are provided via a structure called a semiconductor wafer. Semiconductor wafers may be used to produce integrated circuits (ICs) having the performance and size characteristics desirable for a particular component.

Since modern ICs can be manufactured to such small scales, any defects on the ICs may have a relatively large impact on performance. To minimize losses due to defective wafers and thereby maximize wafer yield, great care is taken during the production of the wafers to attempt to prevent defects from being created and to also detect any defects so that failed wafers can be removed before they are delivered to consumers. Elimination of certain process irregularities can assist in the reduction of the incidence of wafer failure.

One example of a production process in which certain irregularities may cause wafer damage may be the baking of wafers during a photolithography process. For example, a typical photolithography operation may include one or more steps of baking the wafer on a hot plate. FIG. 1 illustrates an example of a wafer 10 on a hot plate 12 for the purpose of baking the wafer 10. To assist in aligning the wafer 10 to provide a consistent amount of heat over the surface of the wafer 10, the hot plate 12 may have guides 14 between which the wafer may be intended to sit in contact with the hot plate 12. With uniform heating over the surface of the wafer 10, the baking may occur evenly over the wafer 10, and wafer processing may continue according to the other photolithography steps without the baking operation causing any problems. However, if the wafer 10 is tilted for some reason, the wafer 10 may not heat uniformly and the processing of the wafer 10 may be impacted to the point where the wafer 10 ends up being defective.

FIG. 2 illustrates an example of a tilted wafer 20 that has one end caught up on one of the guides 14. The tilting of the wafer may be caused by having a particle of foreign material on the hot plate 12, or other defective conditions as well. Regardless of the cause, the wafer tilt in FIG. 2 may cause the tilted wafer 20 to have an increased likelihood of being defective. Thus, it may be desirable to provide an ability to detect situations where wafer tilt has occurred.

### BRIEF SUMMARY OF EXEMPLARY EMBODIMENTS

Embodiments of the present invention are therefore provided that may enable the provision of a system for the accurate detection of wafer tilt. Yield loss rates may therefore be reduced and production may be facilitated.

In an example embodiment, a method of improving wafer yield by accurately identifying tilted wafer conditions is provided. The method may include providing inquiry signals in gaps defined between machine signals where the inquiry signals relate to temperature information indicative of a temperature of a hot plate having an item placed thereon, receiving the temperature information, and determining a seating condition of the item based on a comparison of the temperature information to an expected heat profile for a fully seated item.

In another example embodiment, an apparatus for improving wafer yield by accurately identifying tilted wafer conditions is provided. The apparatus may include a processor configured to control a monitoring station with respect to providing inquiry signals in gaps defined between machine signals where the inquiry signals relate to temperature information indicative of a temperature of a hot plate having an item placed thereon, receiving the temperature information, and determining a seating condition of the item based on a comparison of the temperature information to an expected heat profile for a fully seated item.

It is to be understood that the foregoing general description and the following detailed description are exemplary, and are not intended to limit the scope of the invention.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an example of a wafer on a hot plate for the purpose of baking the wafer according to an example embodiment of the present invention;

FIG. 2 illustrates an example of a tilted wafer condition that may be addressed and identified according to an example embodiment of the present invention;

FIG. 3 illustrates an architecture of a system for providing detection of wafer tilt to enable the provision of improved wafer yield according to an example embodiment of the present invention;

FIG. 4 illustrates a theoretical wafer baking temperature curve according to an example embodiment of the present invention;

FIG. 5 illustrates a distorted wafer baking temperature curve due to having a long sampling frequency;

FIG. 6 illustrates examples of overlap between machine signals and inquiry signals that may initiate false alarms or warnings;

FIG. 7 illustrates an example of shorter inquiry signals utilized to avoid overlap between machine signals and inquiry signals according to an example embodiment of the present invention;

FIG. 8 illustrates an example of a series of machine instructions and an illustration of the gaps in which commands may be inserted without overlap according to an example embodiment of the present invention;

FIG. 9 illustrates an example of an apparatus for improving wafer yield by accurately identifying tilted wafer conditions according to an example embodiment of the present invention; and

FIG. 10 is a block diagram describing a method for improving wafer yield by accurately identifying tilted wafer conditions according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements.

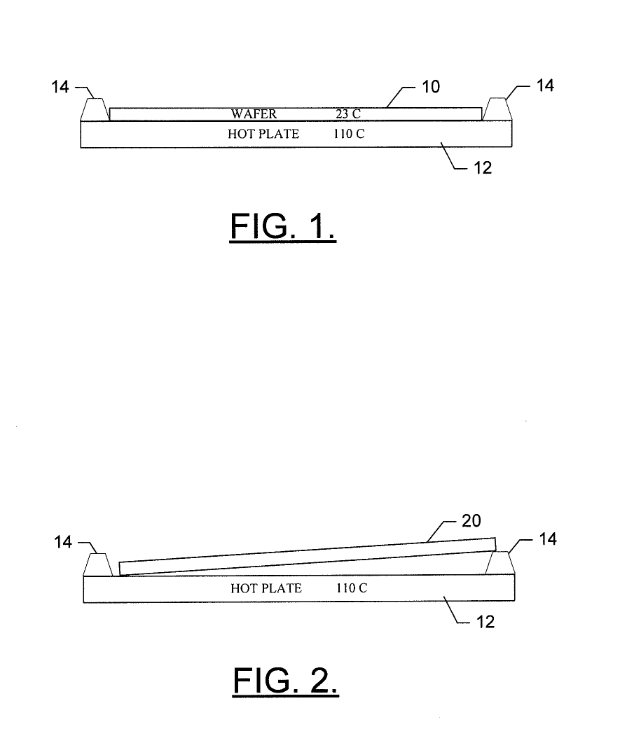

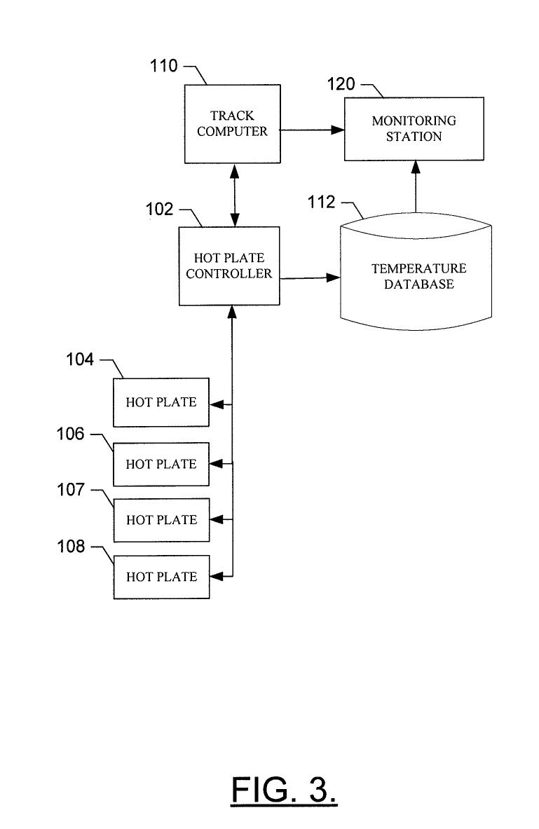

Some embodiments of the present invention may provide a mechanism by which improvements may be experienced in relation to the production of semiconductor device wafers. FIG. 3 illustrates an architecture of a system for providing detection of wafer tilt to enable the provision of improved wafer yield. In this regard, as shown in FIG. 3, the system 100 may include a hot plate controller 102 configured to interface with a hot plate 104 to provide control signals to the hot plate 104 and/or to receive sensor data from the hot plate 104 indicative of one or more temperatures at the hot plate 104 for a wafer or other item on the hot plate 104. In an example embodiment, the hot plate 104 may include one or more temperature sensors and may be configured to detect temperature changes responsive to placing a wafer in contact with the hot plate 104 or heating of the wafer. For example, if the wafer is improperly seated onto the hot plate 104 (as shown in FIG. 2), the temperature reduction noticed at the sensors of the hot plate 104 may be less than the temperature reduction that would otherwise be noticed when a properly seated wafer (as shown in FIG. 1) is placed on the hot plate 104 and can extract heat from the hot plate 104 uniformly over the surface of the wafer. However, regardless of the specific mechanism by which temperature data is generated at the temperature sensors, the hot plate controller 102 may be configured to receive the temperature data and provide such data for storage and/or analysis as described herein. It should also be appreciated that the hot plate controller 102 may further interface with other hot plates (e.g., hot plate 106, hot plate 107 and hot plate 108).

In an example embodiment, a track computer 110 may be used to provide instructions to the hot plate controller such as for temperature control and/or to indicate when to take temperature readings. The track computer 110 may include a processor and memory for storing instructions to direct the track computer 110 to execute corresponding functions or applications defined by the instructions. Temperature data extracted by the hot plate controller 102 may be provided to the track computer 110 (e.g., to determine initial status information) and/or a temperature database 112. In some cases, the temperature database 112 may be a portion of the track computer 110 that may be used for uploading temperature information, and passing the temperature information on to another component (e.g., monitoring station 120) or storing the temperature information within memory of the temperature database 112. However, in other examples, the temperature database 112 may be a component that is separate from the track computer 110.

In an example embodiment, the track computer 110 and the temperature database 112 may be in communication with the monitoring station 120. The monitoring station 120 may in some cases also be a computing device having a processor and memory for storing instructions to direct the monitoring station 120 to execute corresponding functions or applications defined by the instructions as described herein. For example, the monitoring station 120 may be configured to receive and analyze the temperature information to determine whether a tilted wafer condition exists at one or more of the hot plates. In an example embodiment, the temperature information may be provided to the monitoring station 120 in real time or near real time. Thus, tilted wafer conditions may be detected in a timely fashion and corrections may be made prior to damaging tilted wafers. If a tilted wafer condition is detected at one or more of the hot plates (104, 106, 107 or 108), the monitoring station 120 may be configured to either provide a warning to an operator (e.g., to enable the operator to stop baking of the tilted wafer), or to automatically direct the baking process for the corresponding wafer to be stopped (e.g., via control signals to the hot plate controller 102 via the track computer 110). In some cases, reworking of the wafer may then be conducted to provide a new coating of photoresist liquid or otherwise recover the wafer prior to improper baking of the tilted wafer at the corresponding hot plate, and thus potentially also prior to failure of the tilted wafer.

In an example embodiment, the hot plate controller 102 may be configured to sample hot plate temperature information at a pre-defined sampling frequency. In other words, a pre-defined time period may be set to define the periodicity at which hot plate temperatures are sampled. For example, hot plate temperature could be sampled one time every 9 seconds, 3 seconds, or 1 second. However, test data has indicated that in some situations, a longer periodicity between samples may distort the wafer baking temperature curve and lead to false warnings being issued by the monitoring station 120.

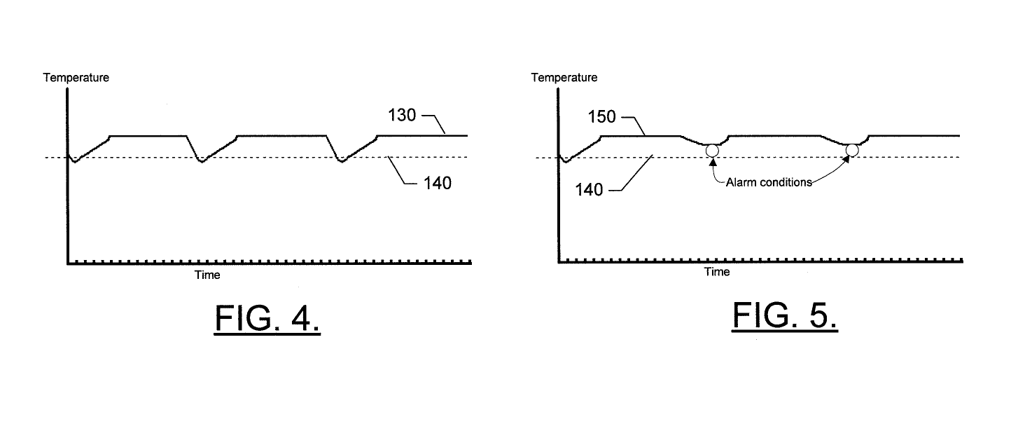

FIG. 4 illustrates an example theoretical wafer baking temperature curve. As can be seen from FIG. 4, the wafer baking temperature curve 130 for a properly seated wafer is expected to see a dip in temperature. Based on the expected temperature dip, it can be determined as to whether the wafer is properly seated. For example, if the temperature does not sufficiently dip as expected, the wafer is likely tilted and therefore not experiencing the expected amount of heat transfer. Thus, a warning trigger specification 140 may be defined. If the temperature curve does not dip at least to the level of the warning trigger specification 140, a tilted wafer condition may be suspected and a warning may be issued (or baking may be stopped). In some cases, such as when data gathering is triggered once every 9 seconds, a distortion to the wafer temperature baking curve may be experienced. FIG. 5 illustrates an actual wafer baking temperature curve 150 experiencing distortion due to having the sampling frequency set too low. In this regard, the distortion of the curve does not accurately pick up the temperature dip. Thus, the curve never appears to get below the warning trigger specification 140 and an alarm or warning condition will therefore be issued even if the wafer is actually properly seated on the hot plate.

To cure the deficiency illustrated by FIG. 5, which may occur when the sampling frequency is low enough to distort the theoretical wafer baking curve of FIG. 4, some example embodiments may employ a higher sampling frequency (e.g., one sample every second). By employing the higher sampling frequency, the actual data that is experienced at the monitoring station 130 may be closer to the real data and therefore, if the wafer is seated properly, closer to the theoretical wafer baking temperature curve. Thus, it can be expected that alarm conditions that are detected are more likely to be associated with wafer tilt than with curve distortion based on sampling frequency.

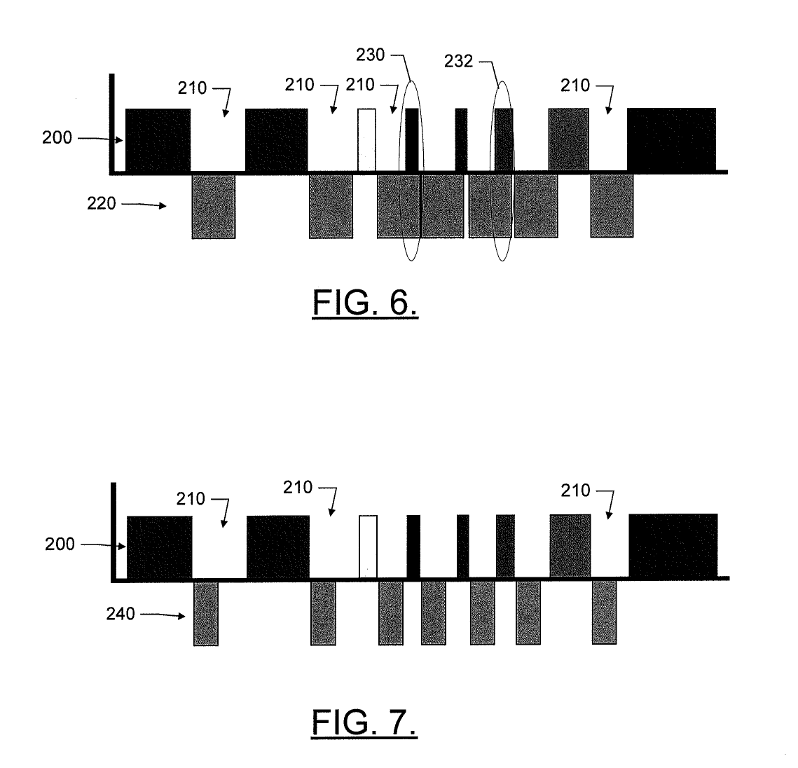

Another potential phenomenon that may interfere with the ability to accurately determine wafer tilt conditions may be interference between machine signals and inquiry signals that are used to obtain the temperature information. The machine signals may include signals for hot plate control or other instructions. Meanwhile, the inquiry signals may be signals that are related to the acquisition of the temperature information. In general, inquiry signals may be inserted after machine signals have been sent, as shown in FIG. 6. FIG. 6 illustrates a plurality of machine signals 200 that are sent with gaps 210 therebetween. Inquiry signals 220 may be sent in the time periods defined by the gaps 210. Moreover, in some cases, the inquiry signals 220 may be sent responsive to the end of a machine signal cycle. The gaps 210 may have varying lengths. However, the inquiry signals 220 may have a consistent length. In some cases, if an inquiry signal is initiated in a gap, and another machine signal is sent prior to the end of the inquiry signal, an overlap condition may occur between the machine signal and the inquiry signal. FIG. 6 illustrates two such examples of overlap (shown within the ovals 230 and 232). This overlap may cause signal interference that may result in tilted wafer warnings or alarms being issued even though the wafer is properly seated.

When a higher sampling frequency is employed, the inquiry signal may be shortened since more cycles of data can be reported within a smaller period of time given the higher sampling frequency. FIG. 7 illustrates an example in which the same machine signals 200 as those shown in FIG. 6 are provided. However, in the example of FIG. 7, inquiry signals 240 are provided with a shorter time interval. The time interval shown in FIG. 7 may be selected to ensure that no overlap occurs. Thus, for example, a high frequency oscillator may be used to calculate the timing associated with each of the gaps 210. A minimum acceptable time interval for each gap area may be determined and the instruction cycle for inquiry signals may be adjusted so that a minimum time control profile is determined. Inserted inquiry signals may have a length that is shorter based on the increased sampling frequency of the hot plate temperatures, and overlap (and corresponding signal interference) may be avoided.

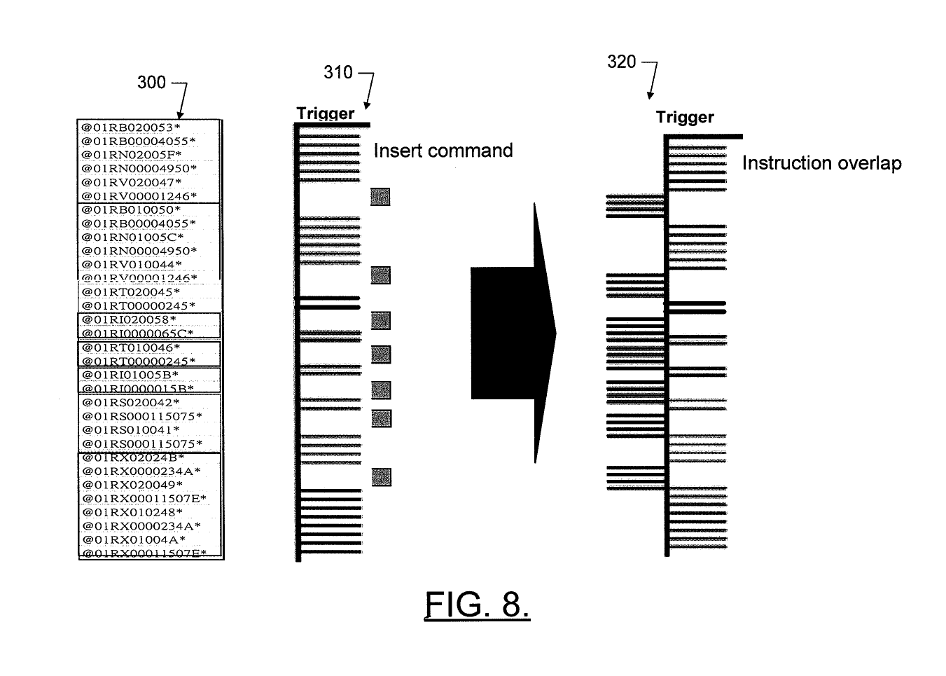

FIG. 8 illustrates an example of a series of machine instructions 300 or triggers, and an illustration 310 of the gaps in which commands may be inserted (e.g., for temperature information gathering). The resulting potential for instruction overlap is then also shown in illustration 320. By increasing the sampling frequency (e.g., from once every nine seconds to once every second), temperature curve accuracy may be improved and instruction overlap may be avoided.

Example embodiments may be used in connection with TEL Clean Track ACT-8 and MK-8 hot plate systems or any other TEL hot plate systems models. Moreover, example embodiments may be used in connection with a circuit for accurately capturing signal returns including hot plate temperature information. Example embodiments could be used with many different hot plate units and with other machines that are monitoring temperatures of various components.

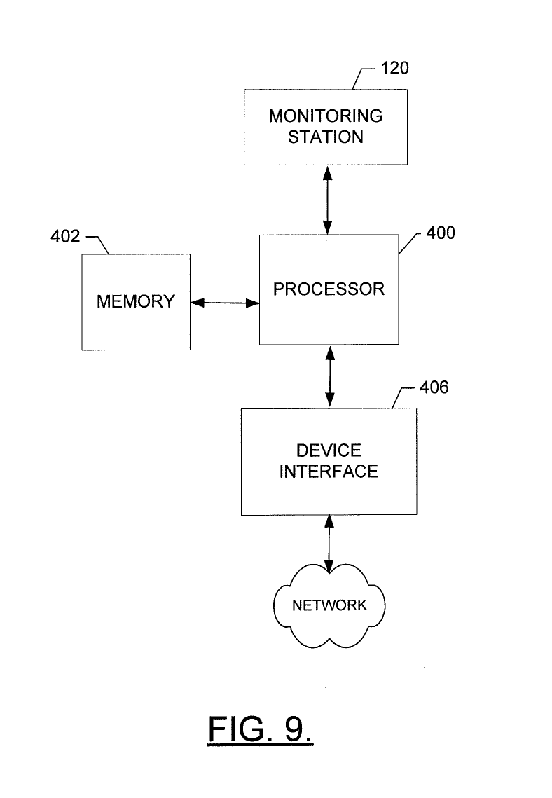

FIG. 9 illustrates a block diagram of an apparatus that may be employed as a portion of the monitoring station 120 (or the tracking computer 110) to execute example embodiments of the present invention. As shown in FIG. 9, the apparatus may include or otherwise be in communication with a processor 400, a memory 402, a user interface 404 and a device interface 406. The memory 402 may include, for example, volatile and/or non-volatile memory (i.e., non-transitory storage medium or media) and may be configured to store information, data, applications, instructions or the like for enabling the apparatus to carry out various functions in accordance with exemplary embodiments of the present application. For example, the memory 402 may be configured to buffer input data for processing by the processor 400 and/or store instructions for execution by the processor 400.

The processor 400 may be embodied in a number of different ways. For example, the processor 400 may be embodied as various processing means such as processing circuitry embodied as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 400 may be configured to execute instructions stored in the memory 402 or otherwise accessible to the processor 400. As such, the processor 400 may be configured to cause various functions to be executed either by execution of instructions stored in the memory 402 or by executing other preprogrammed functions.

The user interface 404 may be in communication with the processor 400 to receive an indication of a user input at the user interface 404 and/or to provide an audible, visual, mechanical or other output to the user. As such, the user interface 404 may include, for example, a keyboard, a mouse, a joystick, a display, a touch screen, soft keys, a microphone, a speaker, or other input/output mechanisms.

Meanwhile, the device interface 406 may be any means such as a device or circuitry embodied in either hardware, software, or a combination of hardware and software that is configured to receive and/or transmit data from/to a network and/or any other device or module in communication with the apparatus. In this regard, the device interface 406 may include, for example, an antenna (or multiple antennas) and supporting hardware and/or software for enabling communications with a wireless communication network. In fixed environments, the device interface 406 may alternatively or also support wired communication. As such, the device interface 406 may include a communication modem and/or other hardware/software for supporting communication via cable, digital subscriber line (DSL), universal serial bus (USB) or other mechanisms.

In an example embodiment, the apparatus may further include the monitoring station 120 (or the tracking computer 110). The monitoring station 120 (or the tracking computer 110) may be embodied as, included within or otherwise controlled by the processor 400. The monitoring station 120 (or the tracking computer 110) may be any means such as a device or circuitry embodied in hardware, software or a combination of hardware and software (e.g., processor 400 operating under software control) that is configured to perform the corresponding functions of the monitoring station 120 (or the tracking computer 110) for detecting tilted wafer conditions, as described herein.

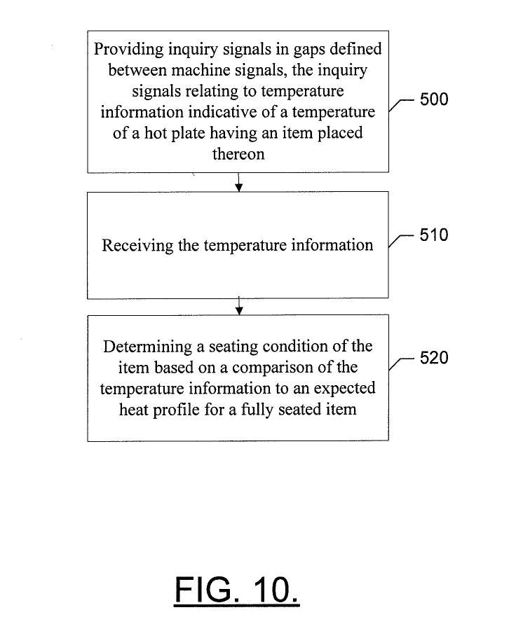

FIG. 10 is a flowchart illustrating operations associated with example methods of improving wafer yield by accurately identifying tilted wafer conditions according to an example embodiment. It should be understood that each block of the flowchart, and combinations of blocks in the flowchart, can be implemented by various means, such as hardware, firmware, and/or software including one or more computer program instructions. For example, one or more of the procedures described herein may be embodied by computer program instructions. In this regard, the computer program instructions which embody the procedures described above may be stored by a memory and executed by a processor. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s). These computer program instructions may also be stored in a computer-readable electronic storage memory that can direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowcharts, and combinations of blocks in the flowchart, can be implemented by special purpose hardware-based computer systems which perform the specified functions or operations, or combinations of special purpose hardware and computer instructions.

As shown in FIG. 10, a method for providing inquiry signals in gaps defined between machine signals at operation 500. The inquiry signals may relate to temperature information indicative of a temperature of a hot plate having an item placed thereon. The method may further include receiving the temperature information at operation 510 and determining a seating condition (e.g., fully seated on the hot plate or tilted) of the item based on a comparison of the temperature information to an expected heat profile for a fully seated item at operation 520.

In some embodiments, the operations above may be modified or amplified as described below. Some or all of the modifications and/or amplifications may be combined in some embodiments. For example, in some cases, providing inquiry signals may include determining a time profile indicative of a duration of the gaps and defining a duration of the inquiry signals based on the time profile. In an example embodiment, providing inquiry signals may include determining the time profile based on a minimum time between the gaps and defining the duration of the inquiry signals to be less than the minimum time. In some cases, receiving the temperature information may include receiving the temperature information at a sampling frequency of one sample per second. In some embodiments, determining the seating condition may include determining whether the item is fully seated or tilted with respect to a surface of the hot plate based on proximity of a temperature profile of the temperature information to a warning trigger specification. In an example embodiment, determining whether the item is fully seated or tilted may include determining a tilted condition in response to the temperature profile failing to dip to a level of the warning trigger specification. The item may be a semiconductor wafer, and in some cases, providing the inquiry signals and receiving the temperature information may include providing inquiry signals and receiving temperature information regarding a plurality of semiconductor wafers.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing inquiry signals in gaps defined between machine signals, the inquiry signals relating to temperature information indicative of a temperature of a hot plate having an item placed thereon;
receiving the temperature information; and
determining a seating condition of the item based on a comparison of the temperature information to an expected heat profile for a fully seated item.

2. The method of claim 1, wherein providing inquiry signals comprises determining a time profile indicative of a duration of the gaps, and defining a duration of the inquiry signals based on the time profile.

3. The method of claim 3, wherein providing inquiry signals comprises determining the time profile based on a minimum time between the gaps, and defining the duration of the inquiry signals to be less than the minimum time.

4. The method of claim 1, wherein receiving the temperature information comprises receiving the temperature information at a sampling frequency of one sample per second.

5. The method of claim 1, wherein determining the seating condition comprises determining whether the item is fully seated or tilted with respect to a surface of the hot plate based on proximity of a temperature profile of the temperature information to a warning trigger specification.

6. The method of claim 5, wherein determining whether the item is fully seated or tilted comprises determining a tilted condition in response to the temperature profile failing to decrease to a level of the warning trigger specification.

7. The method of claim 1, wherein the item comprises a semiconductor wafer.

8. The method of claim 1, wherein providing the inquiry signals and receiving the temperature information comprises providing inquiry signals and receiving temperature information regarding a plurality of semiconductor wafers.

9. An apparatus comprising a processor configured to control a monitoring station that is configured to:
provide inquiry signals in gaps defined between machine signals, the inquiry signals relating to temperature information indicative of a temperature of a hot plate having an item placed thereon;
receive the temperature information; and
determine a seating condition of the item based on a comparison of the temperature information to an expected heat profile for a fully seated item.

10. The apparatus of claim 9, wherein the processor is configured to control the monitoring station with respect to providing inquiry signals by determining a time profile indicative of a duration of the gaps, and defining a duration of the inquiry signals based on the time profile.

11. The apparatus of claim 10, wherein the processor is configured to control the monitoring station with respect to providing inquiry signals by determining the time profile based on a minimum time between the gaps, and defining the duration of the inquiry signals to be less than the minimum time.

12. The apparatus of claim 9, wherein the processor is configured to control the monitoring station with respect to receiving the temperature information by receiving the temperature information at a sampling frequency of one sample per second.

13. The apparatus of claim 9, wherein the processor is configured to control the monitoring station with respect to determining the seating condition by determining whether the item is fully seated or tilted with respect to a surface of the hot plate based on proximity of a temperature profile of the temperature information to a warning trigger specification.

14. The apparatus of claim 13, wherein the processor is configured to control the monitoring station with respect to determining whether the item is fully seated or tilted by determining a tilted condition in response to the temperature profile failing to decrease to a level of the warning trigger specification.

15. The apparatus of claim 9, wherein the item comprises a semiconductor wafer.

16. The apparatus of claim 9, wherein the processor is configured to control the monitoring station with respect to providing the inquiry signals and receiving the temperature information by providing inquiry signals and receiving temperature information regarding a plurality of semiconductor wafers.
